(19) United States
(12) Patent Application Publication
(10) Pub. No.: US 2011/0203786 A1
(43) Pub. Date: Aug. 25, 2011

(54) Waste Water Heat Transfer System

(76) Inventors: Brandon Darnell, Carthage, SD (US); Colin Wunder, Howard, SD (US); Lyle Darnell, Carthage, SD (US)

(21) Appl. No.: 12/712,660

(22) Filed: Feb. 25, 2010

(51) Int. Cl. G05D 23/00; F25B 29/00; F28D 7/10; F24H 9/02; E03B 11/10; F25B 1/00

(52) U.S. Cl. 165/287; 165/63; 165/154; 165/47; 137/590; 62/498

(57) ABSTRACT

A waste water heat transfer system for actively transferring heat from waste water to incoming potable water to assist in heating the potable water. The system generally includes a holding tank for receiving wastewater, a heat transfer unit having a refrigeration system and a fluidly connected coaxial heat exchanger, wherein the coaxial heat exchanger receives warmed refrigerant that absorbs heat from the wastewater while travelling through the refrigeration system, a potable water inlet in fluid communication with the coaxial heat exchanger to circulate the potable water within the coaxial heat exchanger and absorb heat from the warmed refrigerant, a buffer tank to receive the warmed potable water from the coaxial heat exchanger, and a hot water heater to receive the warmed potable water from the buffer tank as needed. A controller circuit is used to activate and deactivate the heat transfer unit according to parameters, such as water temperature.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a water heater and more specifically it relates to a waste water heat transfer system for actively transferring heat from waste water to incoming potable water to assist in heating the potable water.

2. Description of the Related Art

Any discussion of the related art throughout the specification should in no way be considered as an admission that such related art is widely known or forms part of common general knowledge in the field.

Water heating systems have been in use for years and are typically used to heat incoming cold potable water to a hot temperature that is suitable for the desired application, such as bathing, washing, etc. Typically, the incoming cold potable water is at a temperature just above freezing, thus requiring the water heater to heat the potable water a substantial amount which can be costly, draining on the water heater, and time consuming.

Large amounts of wastewater are also drained everyday into the sewer system. Often times, the wastewater contains heat and is substantially warmer than the incoming cold potable water. Heating systems have been used to try and capture the heat from the wastewater and transfer that heat to the incoming potable water to reduce the required work of the domestic water heater. However, these systems are generally inefficient due to cost, required space needed, complicated installation, and simply not transferring the heat from the wastewater to the potable water in an efficient manner, wherein the systems generally use a passive heat transfer method which generally does not adequately heat the potable water an amount to justify the cost of installing the heat transfer system. Because of the inherent problems with the related art, there is a need for a new and improved waste water heat transfer system for actively transferring heat from waste water to incoming potable water to assist in heating the potable water.

### BRIEF SUMMARY OF THE INVENTION

A system for actively transferring heat from waste water to incoming potable water to assist in heating the potable water. The invention generally relates to a water heater which includes a holding tank for receiving wastewater, a heat transfer unit having a refrigeration system and a fluidly connected coaxial heat exchanger, wherein the coaxial heat exchanger receives warmed refrigerant that absorbs heat from the wastewater while travelling through the refrigeration system, a potable water inlet in fluid communication with the coaxial heat exchanger to circulate the potable water within the coaxial heat exchanger and absorb heat from the warmed refrigerant, a buffer tank to receive the warmed potable water from the coaxial heat exchanger, and a hot water heater to receive the warmed potable water from the buffer tank as needed. A controller circuit is used to activate and deactivate the heat transfer unit according to parameters, such as water temperature.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a diagrammatic view of the present invention installed within a residential household.

FIG. 2 is a diagrammatic view of the holding tank and heat transfer unit.

FIG. 3 is a diagrammatic view of a portion of the heat transfer unit atop the holding tank.

FIG. 4 is a sectional view taken along lines 4-4 of FIG. 3 illustrating the concentric piping of the coaxial heat exchanger.

FIG. 5 is a diagrammatic view of the buffer tank.

FIG. 6 is a diagrammatic view of the fitting installed within the outlet of the buffer tank with the buffer tank partially cutaway.

FIG. 7 is a schematic view of the controller circuit.

FIG. 8 is a diagrammatic view of the present invention installed within a residential household using flexible connecting hoses to fluidly connect the buffer tank to the heat transfer unit.

### DETAILED DESCRIPTION OF THE INVENTION

### A. Overview.

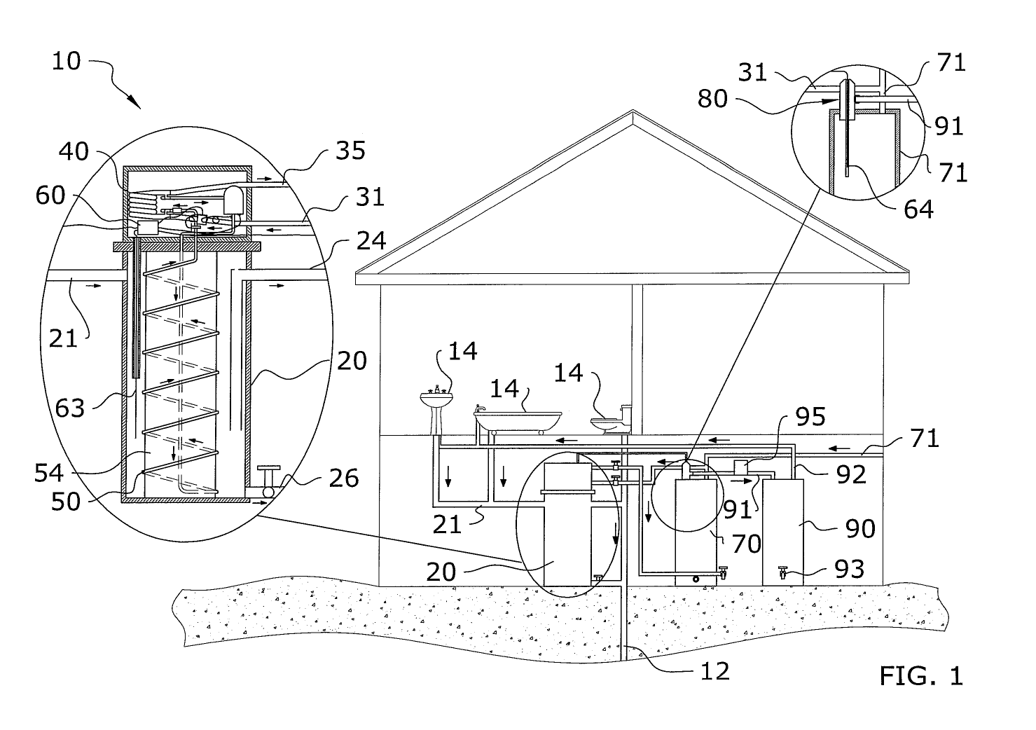

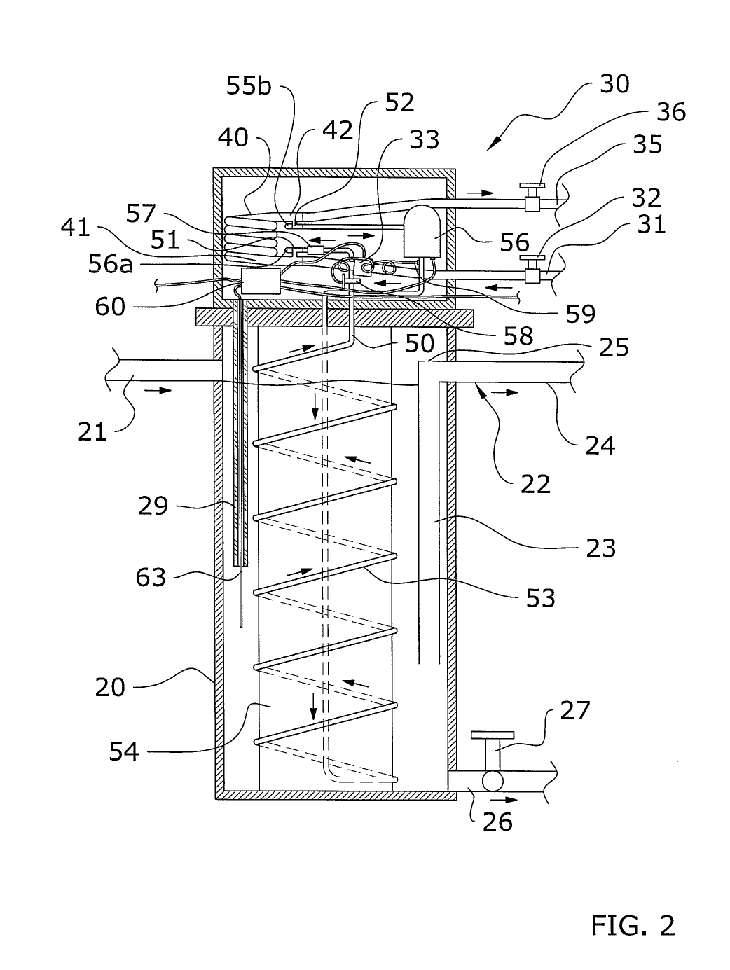

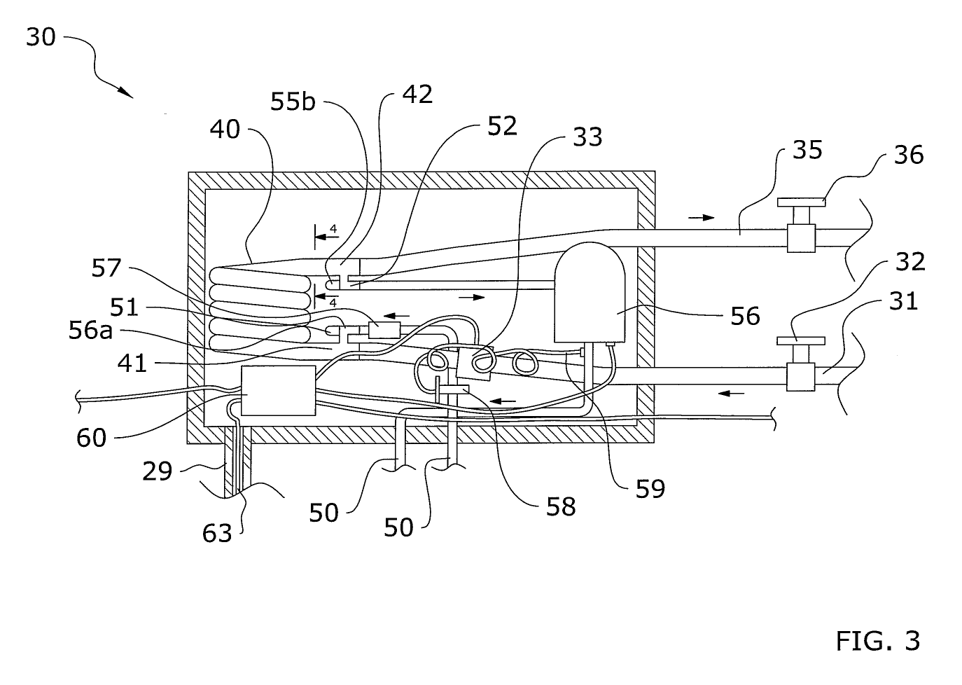

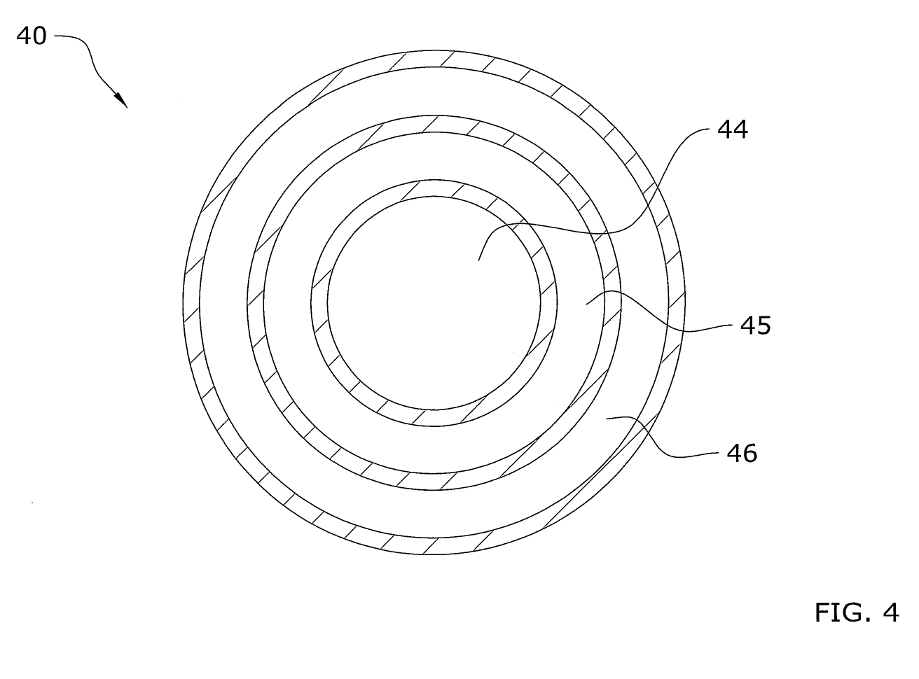

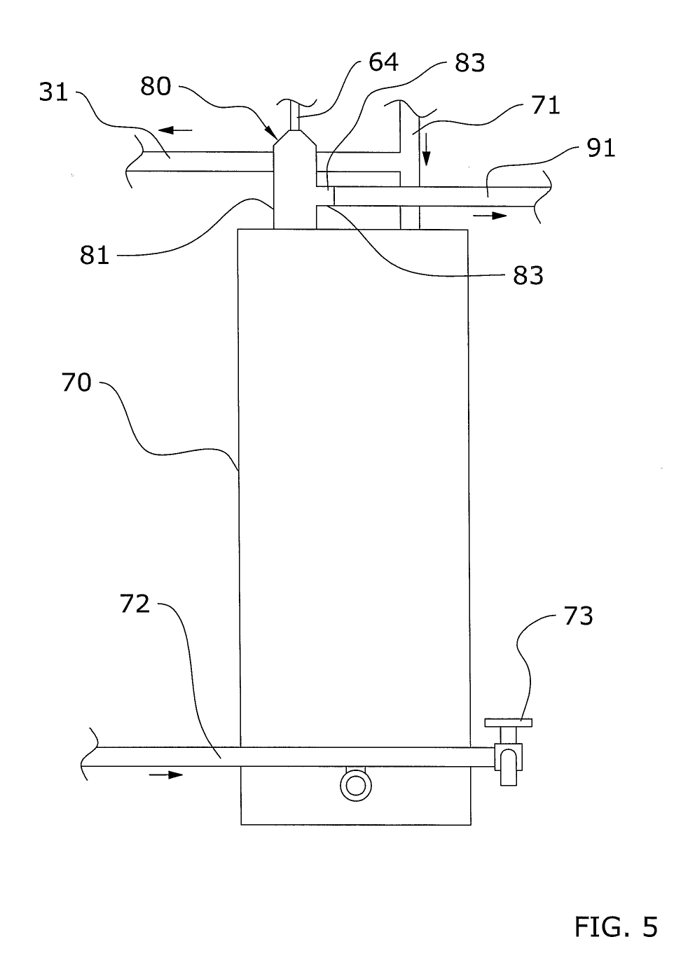

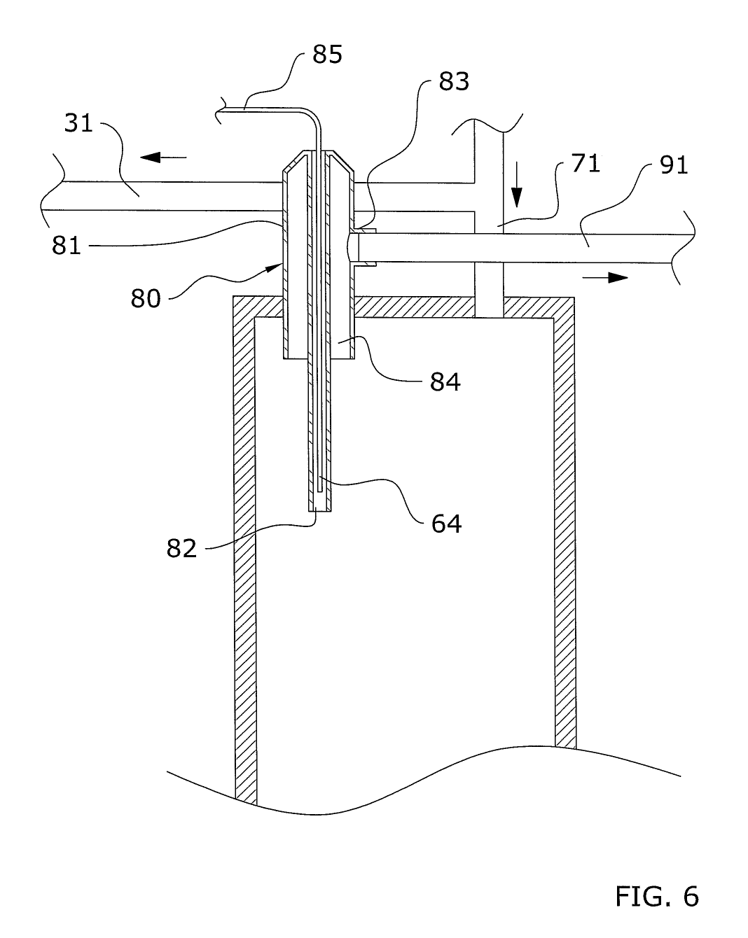

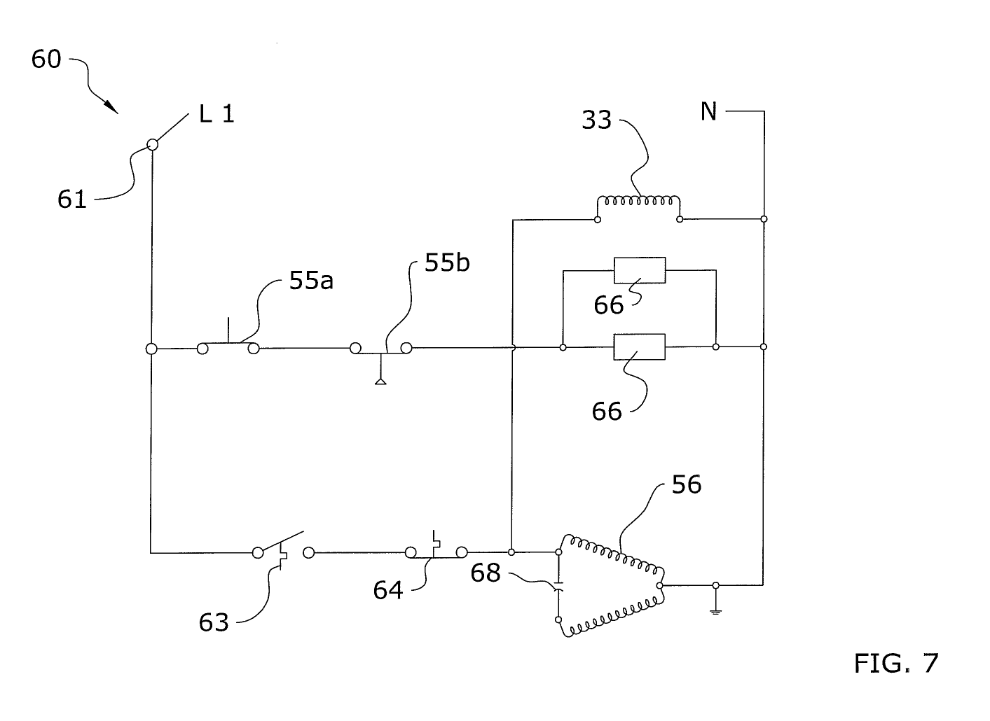

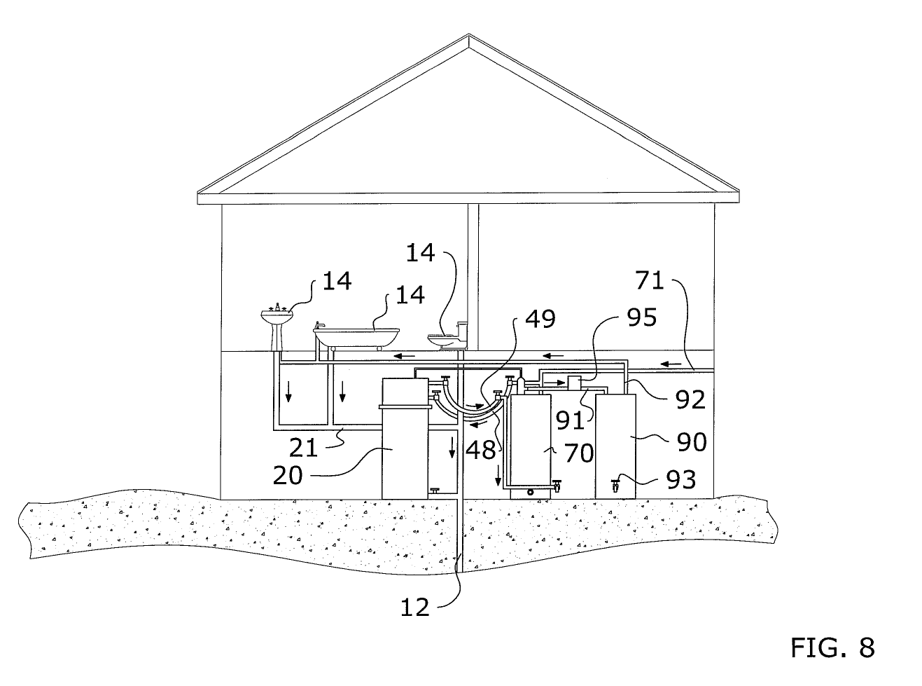

Turning now descriptively to the drawings, in which similar reference characters denote similar elements throughout the several views, FIGS. 1 through 8 illustrate a waste water heat transfer system 10, which comprises a holding tank 20 for receiving wastewater, a heat transfer unit 30 having a refrigeration system and a fluidly connected coaxial heat exchanger 40, wherein the coaxial heat exchanger 40 receives warmed refrigerant that absorbs heat from the wastewater while travelling through the refrigeration system, a potable water inlet 71 in fluid communication with the coaxial heat exchanger 40 to circulate the potable water within the coaxial heat exchanger 40 and absorb heat from the warmed refrigerant, a buffer tank 70 to receive the warmed potable water from the coaxial heat exchanger 40, and a hot water heater 90 to receive the warmed potable water from the buffer tank 70 as needed. A controller circuit 60 is used to activate and deactivate the heat transfer unit 30 according to parameters, such as water temperature. The heat transfer system 10 may be installed with a new hot water heating configuration or may be retrofitted to an existing hot water heating system.

### B. Holding Tank.

The holding tank 20 is of a suitable volume to receive enough wastewater to maintain a stable temperature therewithin. The holding tank 20 may be comprised of various materials and shapes, all which are suitable for holding wastewater for prolonged periods of time. The holding tank 20 is preferably of a cylindrical shape having a removable cover for inspection or maintenance of the evaporator coil 53 therein.

Generally, an inlet pipe 21 is directed within the holding tank 20 near the upper end to direct wastewater (or gray water) within the holding tank 20. The wastewater may be directed from various sources or appliances 14, such as showers, dishwashing, bathing, and others. The holding tank 20 preferably includes a first outlet pipe 22 (i.e. overflow pipe) and a second outlet pipe 26 (i.e. drain pipe) fluidly connected to a sewer pipe 12 in a manner to prevent inflow of the sewer water within the holding tank 20 but allow outflow of the wastewater within the sewer pipe 12 as needed.

The first outlet pipe 22 is used to prevent overfilling the holding tank 20. The first outlet pipe 22 includes a dip tube portion 23 extending vertically towards the bottom of the interior of the holding tank 20 and an overflow portion 24 substantially horizontally extending from the upper end of the dip tube portion 23 to connect the first outlet pipe 22 with the sewer pipe 12.

The lower end of the dip tube portion 23 forms the inlet of the first outlet pipe 22 thus ensuring that the coldest wastewater (near the bottom of the holding tank 20) exits the holding tank 20 prior to the warmer wastewater. The overflow portion 24 is generally a similar height as the inlet pipe 21 and thus at an upper end of the holding tank 20. Thus, the bottom of the overflow portion 24 of the first inlet pipe 22 defines the constant wastewater surface level within the holding tank 20, wherein any wastewater above the bottom of the overflow portion 24 freely flows into the sewer pipe 12.

The first outlet pipe 22 may also include a vent 25 above the surface level of the wastewater to ensure smooth flow of the wastewater through the first outlet pipe 22. The first outlet pipe 22 and/or sewer pipe 12 may also include a trap to prevent up-flow of gases as is needed for regulations, etc.

The second outlet pipe 26 is generally located at a lower end of the holding tank 20 and is used for emptying the holding tank 20 of the wastewater into the sewer pipe 12, such as when cleaning the holding tank 20 or heat transfer unit 30, performing maintenance upon the holding tank 20 or heat transfer unit 30. A valve 27 is located upon the second outlet pipe 26 to selectively close and open flow through the second outlet pipe 26. Various types of valves may be used.

A tube 29 also preferably extends within the holding tank 20 from an upper end of the holding tank 20. The wire tube 29 extends within the wastewater within the holding tank 20 below the surface level of the wastewater and preferably to a point just above the lower end of the dip tube portion. The tube 29 receives and secures a temperature probe 63 for the wastewater in position.

### C. Heat Transfer Unit.

As discussed, the heat transfer unit 30 is for warming the cold potable water prior to the potable water being delivered to the hot water heater 90. Thus, the hot water heater 90 does not have to use as much energy to heat the potable water and the potable water may be heated to a desired hot temperature in a shorter duration of time. The heat transfer unit 30 is preferably in fluid communication with both the wastewater holding tank 20 and a buffer tank 70 that holds the warmed potable water prior to being delivered to the hot water heater 90. It is appreciated that in alternate embodiments, the heat transfer unit 30 may be in direct fluid communication with the hot water heater 90.

The heat transfer unit 30 includes an inlet pipe 31 to receive cold potable water from an inlet pipe 71 leading from a well or fresh water source. The heat transfer unit 30 likewise includes an outlet pipe 35 to deliver the warmed potable water to the buffer tank 70 after circulating through the coaxial heat exchanger 40. The heat transfer unit 30 generally includes at least one valve 32 located upon the inlet pipe 31 and at least one valve 36 located upon the outlet pipe 35 for instances when the heat transfer unit 30 is not utilized and the warm potable water is heated in a conventional manner through the hot water heater 90 alone. At least one water pump 33 is also generally located upon either the inlet pipe 31 or the outlet pipe 35 for circulating the potable water therethrough. Various types of valves may be used, such as but not limited to ball-type valves.

It is appreciated that in alternate embodiments, rather than rigid piping structures, the inlet pipe 31 and/or the outlet pipe 35 may be connected to flexible hoses 48, 49, such as when the system 10 is retrofitted to an existing hot water heating system or other instances. In the case of the flexible hoses, a valve is generally located at each end of the inlet flexible hose 48 and the outlet flexible hose 49.

The inlet pipe 31 and the outlet pipe 35 are fluidly connected via a coil, such as a coaxial heat exchanger 40 generally positioned external to the wastewater holding tank 20 and preferably atop the holding tank 20 and may be substantially enclosed within a casing. The coaxial heat exchanger 40 generally includes a concentric inner channel 44 and a concentric outer channel 46, which are separated via a concentric vented air gap 45 to prevent any portion of the liquid within the outer channel 46 from mixing with the liquid within the inner channel 44. Thus, the air gap channel 45 forms a double-wall between the inner channel 44 and the outer channel 46. In the preferred embodiment, the potable water circulates within the inner channel 44 and warmed refrigerant simultaneously circulates within the outer channel 46. As the cold potable water flows through the inner channel 44, the heat from the warmed refrigerant within the outer channel 46 is absorbed by the cold potable water within the inner channel 44, thus heating the potable water to a warm state prior to exiting the coaxial heat exchanger 40 to the outlet pipe 35.

The refrigerant system is used to heat the refrigerant and circulate the refrigerant through piping 50. The refrigerant is heated via the heat being transferred from the wastewater to the refrigerant within another coil 53 substantially immersed within the wastewater of the holding tank 20 and wrapped around a cylindrical support 54 also immersed within the holding tank 20. A first end 51 of the refrigerant piping 50 generally extends from the inlet 41 of the coaxial heat exchanger 40 and a second end 52 of the refrigerant piping 50 generally extends from the outlet 42 of the coaxial heat exchanger 40 to fluidly circulate the refrigerant within the outer channel 46 of the coaxial heat exchanger 40 from the refrigerant piping 50.

The refrigerant piping 50 generally forms an evaporator coil 53 section within holding tank 20 that is immersed substantially within the warm wastewater, thus allowing the refrigerant within the evaporator coil 53 to receive heat being transferred from the wastewater as the refrigerant is circulated therethrough. The coiled section 53 is preferably oriented in a vertically stacked manner within the holding tank 20 thus encompassing as wide an area as possible to ensure a maximum amount of heat is absorbed from the wastewater via a maximum amount of refrigerant piping 50 being within the wastewater.

The refrigerant piping 50 also includes various mechanisms to allow for the evaporation and expansion of the refrigerant during the cooling and warming process of the refrigerant, such as the compressor 56, expansion valve 58, tube 59, filter dryer 57, and high/low pressure switches 55a, 55b. The compressor 56 compresses the refrigerant gas within the refrigerant piping 50 thus raising the temperature and pressure of the refrigerant so the heat of the refrigerant may be dissipated within the coaxial heat exchanger 40 to the potable water. As the refrigerant cools, the refrigerant condenses to a liquid state and flows through the expansion valve 58 and then flows back within the coils 53 within the holding tank 20 to absorb the heat from the wastewater and repeat a warming cycle of the potable water. The pressure switches 55a, 55b are installed to deactivate the refrigeration system automatically, in order to protect the compressor 50, should refrigeration pressures become too high or too low.

The controller circuit 60 is generally enclosed within a casing and may include various types of interfaces or switches connected to correlating components and displaying relevant values or states of the system 10. Generally, the controller circuit 60 is connected to an AC power supply 61, however DC power supplies may also be utilized, and is connected to the temperature probes 63, 64 of the wastewater holding tank 20, the buffer tank 70, a logic controller 66 to determine whether a current temperature of the wastewater, warmed potable water, or hot potable should cause the heat transfer unit 30 to turn on/off, the pump motor, compressor 56, and relevant capacitor(s) 68.

Generally, the logic controller 66 determines whether the controller circuit 60 should cut power to the heat transfer unit 30 or allow power thereto depending upon water temperatures of the wastewater, and/or warmed potable water within the buffer tank 70. For example, if the wastewater temperature measured by the first temperature sensor 63 falls below a predetermined temperature, such as but not limited 40 degrees, the heat transfer unit 30 will turn off. If the temperature of the warmed potable water is below a predetermined temperature, the heat transfer unit 30 may activate to warm the potable water. Various other methods of determining an active or inactive state of the heat transfer unit 30 and relative components may be appreciated and utilized with the present invention.

### D. Buffer Tank.

The buffer tank 70 is of a suitable volume to receive enough warmed potable water to provide constant warmed potable water to the hot water heater 90 to ensure the hot water heater 90 always has warmed potable water. The buffer tank 70 may be comprised of various materials and shapes, all which are suitable for holding potable water for prolonged periods of time. The buffer tank 70 is preferably of a sealed cylindrical structure. The buffer tank 70 is generally not connected to a power source, wherein the buffer tank 70 simply serves the purpose of receiving the warmed potable water and transferring the warmed potable water to the hot water heater 90 as needed.

Generally, a first inlet pipe 71 is directed within the buffer tank 70 near the upper end to direct cold potable water within the buffer tank 70 if the heat transfer unit 30 is deactivated. If the heat transfer unit 30 is activated, the cold potable water from the first inlet pipe 71 is diverted towards the coaxial heat exchanger 40 of the heat transfer unit 30 prior to entering the buffer tank 70. The buffer tank 70 also preferably includes a second inlet pipe 72 preferably directed into the buffer tank 70 at a lower end and leading from the outlet 35 of the coaxial heat exchanger 40. A valve 73 of various types may also be located upon the second inlet pipe 72 generally past the inlet of the buffer tank 70 relative a flow of the warmed potable water. The warmed potable water is preferably warmed by the coaxial heat exchanger 40 to within approximately 10 degrees Fahrenheit of being ready for domestic use, such as an outputted temperature from the hot water heater 90.

The buffer tank 70 also includes an outlet leading from an upper end of the buffer tank 70 which is comprised of a fitting 80. The fitting 80 is received within the outlet for allowing warmed potable water to travel therethrough towards the hot water heater 90 and also for receiving a temperature probe 64 to be inserted within the buffer tank 70 to measure the temperature of the potable water.

The fitting 80 generally has a vertical portion 81 having a tapered upper end and a first inner concentric passageway 82 extending therethrough. The fitting 80 also has a horizontal portion 83 laterally extending from the vertical portion 81 for connecting to another pipe, such as the inlet pipe 91 of the hot water heater 90. Surrounding the first concentric passageway 82 within the vertical portion 81 is another second concentric passageway 84 for water to flow therethrough and fluidly connect to the inlet pipe 91 connected to the horizontal portion 83. The temperature sensor 64 extends within the inner passageway 82 and the water is able to flow through the outer passageway 84. The inner passageway 82 and the outer passageway 84 are also preferably fluidly separated within the vertical portion 81 to prevent the water flow from disturbing the temperature sensor 64.

### E. Hot Water Heater.

The hot water heater 90 is of a suitable volume to receive enough warmed potable water to provide constant warmed potable water to various domestic appliances 14 or for other applications. The hot water heater 90 may be comprised of various materials and shapes, all which are suitable for holding potable water for prolonged periods of time. The hot water heater 90 is preferably of a sealed cylindrical structure.

The inlet pipe 91 of the hot water heater 90 generally leads from the buffer tank 70 to deliver warmed potable water to the hot water heater 90. An expansion tank 95 may also be located in fluid communication with the hot water heater 90 and inlet pipe 91 to absorb excess water pressure. The hot water heater 90 also generally includes an outlet pipe 92 to release hot potable water and a valve 93. Generally, the hot water heater 90 is only required to heat the potable water a few degrees, wherein most of the heating of the potable water takes place as the potable water circulates through the coaxial heat exchanger 40.

### F. Operation of Preferred Embodiment.

In use, the buffer tank 70 and primary water heater are initially filled with potable water from the main or well source. Likewise, the holding tank 20 is also filled with wastewater. Once filled, the heat transfer unit 30 is activated.

The controller circuit 60 is generally set to start the compressor 56 and stop the compressor 56 at a low set-point of 40 degrees Fahrenheit, which is generally measured by the temperature sensor 63. The controller circuit 60 is also generally set to stop the compressor 56 at 110 degrees Fahrenheit potable water within the buffer tank 70, which is generally measured by the temperature sensor 64. The temperature set limits may be adjusted as needed or desired.

As hot potable water is drawn from the hot water heater 90, the resultant wastewater (from use of the hot potable water) is drained into the wastewater holding tank 20. As the wastewater enters the holding tank 20, the tank overfills into the sewer pipe 12, with preferably the colder wastewater draining from the holding tank 20 prior to the warmed wastewater. As the filling and overfilling of the wastewater holding tank 20 continues, the temperature rises and eventually stabilized.

While the compressor 56 is activated, the refrigerant circulates within the refrigerant piping 50 through the evaporator coil 53 and through the coaxial heat exchanger 40. As the refrigerant circulates through the evaporator coil 53, the refrigerant absorbs the heat from the wastewater. The heated refrigerant then circulates through the coaxial heat exchanger 40. As the cold potable water from the main or well source, or the buffer tank 70, is circulated through the coaxial heat exchanger 40 the cold potable water then absorbs the heat from the refrigerant and returns to the buffer tank 70, where it is stored and delivered to the hot water heater 90 as needed to complete heating of the potable water.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. A waste water heat transfer system, comprising:
a holding tank for receiving wastewater;
a heat transfer unit having a refrigeration system, wherein said refrigeration system is at least partially immersed within said wastewater of said holding tank and is adapted to circulate a refrigerant therewithin to absorb heat from said wastewater;
wherein said heat transfer unit includes a coaxial heat exchanger in fluid communication with said refrigerant flow of said refrigeration system, wherein said coaxial heat exchanger is external to said holding tank and receives said warmed refrigerant within a first concentric pipe of said coaxial heat exchanger;
a potable water inlet in fluid communication with said coaxial heat exchanger;
wherein potable water from said potable water inlet circulates within said coaxial heat exchanger through a second concentric pipe of said coaxial heat exchanger alongside said warmed refrigerant within said first concentric pipe to absorb heat from said warmed refrigerant; and
a buffer tank in fluid communication with said coaxial heat exchanger, wherein said buffer tank is adapted to selectively receive said warmed potable water from said coaxial heat exchanger.

2. The waste water heat transfer system of claim 1, wherein said holding tank includes a first outlet near an upper end of said holding tank for wastewater overflow and a second outlet near a lower end of said holding tank for draining said holding tank, wherein said first outlet and said second outlet are fluidly connected to a sewer pipe.

3. The waste water heat transfer system of claim 2, including an overflow pipe leading to said first outlet, wherein said overflow pipe extends toward said lower end of said holding tank so that an inlet of said overflow pipe is at said lower end.

4. The waste water heat transfer system of claim 3, wherein said overflow pipe is comprised of an L-shaped structure.

5. The waste water heat transfer system of claim 1, wherein said refrigeration system includes an evaporator coil, wherein said evaporator coil is immersed within said wastewater of said holding tank.

6. The waste water heat transfer system of claim 1, including a hot water heater in fluid communication for said buffer tank.

7. The waste water heat transfer system of claim 6, including an integral one-piece fitting forming an outlet for said warmed potable water within said buffer tank, wherein said fitting includes:
a vertical portion having an inner passageway and an outer passageway extending therethrough, wherein said inner passageway and said outer passageway are concentric and wherein said inner passageway and said outer passageway are fluidly separated; and
a horizontal portion laterally extending from said vertical portion, wherein said outer passageway extends through said horizontal portion;
wherein said warmed potable water is adapted to flow through said outer passageway.

8. The waste water heat transfer system of claim 7, including a temperature probe extended through said inner passageway of said fitting and adapted to measure a temperature of said potable water within said buffer tank.

9. The waste water heat transfer system of claim 1, including a controller circuit electrically connected to said heat transfer unit, wherein said controller circuit is adapted to activate said heat transfer unit according to a temperature of said wastewater or said warmed potable water.

10. A waste water heat transfer system, comprising:
a holding tank for receiving wastewater;
a heat transfer unit having a refrigeration system, wherein said refrigeration system is at least partially immersed within said wastewater of said holding tank and is adapted to circulate a refrigerant therewithin to absorb heat from said wastewater;
wherein said heat transfer unit includes a coaxial heat exchanger in fluid communication with said refrigerant flow of said refrigeration system, wherein said coaxial heat exchanger is external to said holding tank and receives said warmed refrigerant within a first concentric pipe of said coaxial heat exchanger;
a potable water inlet in fluid communication with said coaxial heat exchanger;
wherein potable water from said potable water inlet circulates within said coaxial heat exchanger through a second concentric pipe of said coaxial heat exchanger alongside said warmed refrigerant within said first concentric pipe to absorb heat from said warmed refrigerant;
a buffer tank in fluid communication with said coaxial heat exchanger, wherein said buffer tank is adapted to selectively receive said warmed potable water from said coaxial heat exchanger;
a hot water heater in fluid communication with said buffer tank, wherein said hot water heater is adapted to selectively receive said warmed potable water from said buffer tank; and
a controller circuit electrically connected to said heat transfer unit, wherein said controller circuit is adapted to activate and deactivate said heat transfer unit according to a temperature of said wastewater, or said warmed potable water within said buffer tank.

11. The waste water heat transfer system of claim 10, including a temperature sensor within said wastewater of said holding tank, wherein said temperature sensor is connected to said controller circuit and is adapted to deactivate said heat transfer unit if a temperature of said wastewater falls below a predetermined temperature.

12. The waste water heat transfer system of claim 10, including a temperature sensor within said potable water of said buffer tank.

13. The waste water heat transfer system of claim 12, wherein said temperature sensor is connected to said controller circuit and is adapted to deactivate said heat transfer unit if a temperature of said warmed potable water rises above a predetermined temperature.

14. The waste water heat transfer system of claim 10, wherein said holding tank includes a first outlet near an upper end of said holding tank for wastewater overflow and a second outlet near a lower end of said holding tank for draining said holding tank, wherein said first outlet and said second outlet are fluidly connected to a sewer pipe.

15. The waste water heat transfer system of claim 14, including an overflow pipe leading to said first outlet, wherein said overflow pipe extends toward said lower end of said holding tank so that an inlet of said overflow pipe is at said lower end.

16. The waste water heat transfer system of claim 15, wherein said overflow pipe is comprised of an L-shaped structure and includes a vent at an upper end above a surface level of said wastewater within said holding tank.

17. The waste water heat transfer system of claim 10, wherein said refrigeration system includes an evaporator coil, wherein said evaporator coil is immersed within said wastewater of said holding tank.

18. The waste water heat transfer system of claim 10, including an integral one-piece fitting forming an outlet for said warmed potable water within said buffer tank, wherein said fitting includes:
a vertical portion having an inner passageway and an outer passageway extending therethrough, wherein said inner passageway and said outer passageway are concentric and wherein said inner passageway and said outer passageway are fluidly separated; and
a horizontal portion laterally extending from said vertical portion, wherein said outer passageway extends through said horizontal portion;
wherein said warmed potable water is adapted to flow through said outer passageway.

19. The waste water heat transfer system of claim 18, including a temperature probe extended through said inner passageway of said fitting and adapted to measure a temperature of said potable water within said buffer tank.

20. A waste water heat transfer system, comprising:
a holding tank for receiving wastewater;
wherein said holding tank includes a first outlet near an upper end of said holding tank for wastewater overflow and a second outlet near a lower end of said holding tank for draining said holding tank;
wherein said first outlet and said second outlet are fluidly connected to a sewer pipe;
an overflow pipe leading to said first outlet, wherein said overflow pipe extends toward said lower end of said holding tank so that an inlet of said overflow pipe is at said lower end;
wherein said overflow pipe is comprised of an L-shaped structure and includes a vent at an upper end above a surface level of said wastewater within said holding tank;
a heat transfer unit having a refrigeration system, wherein said refrigeration system is at least partially immersed within said wastewater of said holding tank and is adapted to circulate a refrigerant therewithin to absorb heat from said wastewater;
wherein said refrigeration system includes an evaporator coil, wherein said evaporator coil is immersed within said wastewater of said holding tank;
wherein said refrigeration system includes a compressor to move said refrigerant through said refrigerant system;
wherein said heat transfer unit includes a coaxial heat exchanger in fluid communication with said refrigerant flow of said refrigeration system;
wherein said coaxial heat exchanger includes a first concentric channel, a second concentric channel, and a third concentric channel;
wherein said second concentric channel is between said first concentric channel and said third concentric channel and is comprised of a vented air gap;
wherein said coaxial heat exchanger is external to said holding tank and receives said warmed refrigerant within said third concentric channel of said coaxial heat exchanger;
a potable water inlet in fluid communication with said coaxial heat exchanger;
wherein potable water from said potable water inlet circulates within said coaxial heat exchanger through said first concentric channel of said coaxial heat exchanger with said warmed refrigerant within said third concentric channel to absorb heat from said warmed refrigerant;
a buffer tank in fluid communication with said coaxial heat exchanger, wherein said buffer tank is adapted to selectively receive said warmed potable water from said coaxial heat exchanger;
an integral one-piece fitting forming an outlet for said warmed potable water within said buffer tank;
wherein said fitting includes a vertical portion having an inner passageway and an outer passageway extending therethrough, wherein said inner passageway and said outer passageway are concentric and wherein said inner passageway and said outer passageway are fluidly separated;
wherein said fitting includes a horizontal portion laterally extending from said vertical portion, wherein said outer passageway extends through said horizontal portion;
wherein said warmed potable water is adapted to flow through said outer passageway.
a hot water heater in fluid communication with said buffer tank, wherein said hot water heater is adapted to selectively receive said warmed potable water from said buffer tank;
a controller circuit electrically connected to said heat transfer unit, wherein said controller circuit is adapted to activate and deactivate said heat transfer unit according to a temperature of said wastewater or said warmed potable water within said buffer tank;
a first temperature sensor within said wastewater of said holding tank;
wherein said first temperature sensor is connected to said controller circuit and is adapted to deactivate said heat transfer unit if a temperature of said wastewater falls below a first predetermined temperature; and
a second temperature sensor within said potable water of said buffer tank and extending through said inner passageway of said vertical portion of said fitting;
wherein said second temperature sensor is connected to said controller circuit and is adapted to deactivate said heat transfer unit if a temperature of said warmed potable water rises above a second predetermined temperature.
